(19) United States
(12) Patent Application Publication
(10) Pub. No.: US 2015/0114229 A1
(43) Pub. Date: Apr. 30, 2015

(54) METHOD AND SYSTEM FOR ONLINE REPLACEMENT OF GAS TURBINE INLET AIR FILTER ELEMENTS

(71) Applicant: BHA Altair, LLC, Franklin, TN (US)

(72) Inventors: Susanta Kumar Rout, Bangalore (IN); Siddharth Girishkumar Upadhyay, Bangalore (IN); Stephen David Hiner, Salisbury (GB); Etienne René Jarrier, Basingstoke (GB)

(73) Assignee: BHA Altair, LLC, Franklin, TN (US)

(21) Appl. No.: 14/066,067

(22) Filed: Oct. 29, 2013

(51) Int. Cl. B01D 46/00

(52) U.S. Cl. CPC B01D 46/008; B01D 46/002
USPC 95/286; 55/478

(57) ABSTRACT

A method and system for online filter element replacement are provided. The system includes a filter chamber and a tubesheet dividing the filter chamber into a dirty air compartment and a clean air compartment, the tubesheet including a plurality of apertures therethrough. The system also includes a plurality of filter elements positioned in the dirty air compartment and coupled to the tubesheet in flow communication with a respective one of the plurality of apertures such that air entering the clean air compartment from the dirty air compartment passes through at least some of the plurality of filter elements and respective apertures and a shutter operatively positioned in the clean air compartment and configured to selectably cover at least one of the plurality of apertures.

### BACKGROUND OF THE DISCLOSURE

This description relates to gas filtering, and, more particularly, to a method and systems for maintaining gas filter media while the gas filter system is operating online.

At least some known gas turbine engine inlet air systems provide air to a compressor section of the gas turbine engine via an air filter system. A filtration efficiency of the media elements of the inlet filter system is important to the health of the gas turbine engine compressor. The media elements are known to get clogged by environmental conditions such as fog, rain, snow, dust etc. Such clogging may reduce filtration efficiency while increasing the overall pressure drop across the air filter system. Inlet air pressure loss also can result in the loss of power output for the gas turbine engine as a whole. A high-pressure drop across the inlet filters can also result in structural damage of the inlet air system, such as, collapse of the filter element cage, which could lead to air bypass past the filter elements, contamination of the clean air path, and could result in fouling, corrosion and/or FOD (Foreign Object Damage) of the compressor. A life of the filter elements may depend at least partially on a local environment of the filter elements (dust loading, rainfall, humidity, etc.). To maintain the health of the gas turbine engine, filter elements are replaced or cleaned when a differential pressure across the filter elements exceeds an allowable range, for example, greater than approximately 4.0 inches H₂O. Currently, the gas turbine engine needs to be shut down for the filter element replacement, leading to unit downtime and loss of revenue.

### BRIEF DESCRIPTION OF THE DISCLOSURE

In one embodiment, an online air filter replacement system includes a filter chamber and a tubesheet dividing the filter chamber into a first dirty air compartment and a second clean air compartment, the tubesheet including a plurality of apertures therethrough. The system also includes a plurality of filter elements, each of the plurality of filter elements positioned in the dirty air compartment and coupled to the tubesheet in flow communication with a respective one of the plurality of apertures such that air entering the clean air compartment from the dirty air compartment passes through at least some of the plurality of filter elements and respective apertures and a shutter operatively positioned in the clean air compartment and configured to selectably cover at least one of the plurality of apertures.

In another embodiment, a method of online filter element replacement includes providing a tubesheet that divides a dirty working fluid section and a clean working fluid section and that includes a plurality of apertures configured to permit a first flow of working fluid therethrough, each aperture coupled in flow communication with a respective filter element, the filter elements configured to permit a flow of working fluid therethrough and to restrict a flow of material other than the working fluid therethrough, at least partially blocking the flow of working fluid through at least one aperture using a shutter positioned in the clean working fluid section, and directing a second flow of working fluid through the remainder of the plurality of apertures. The method also includes removing the respective filter element associated with the blocked aperture, coupling a replacement filter element in flow communication with a respective one of the at least one blocked aperture, and unblocking the flow of working fluid through the at least one aperture to return the flow of working fluid to the first flow of working fluid.

In yet another embodiment, a gas turbine engine system includes a gas turbine engine including an air inlet, a filter chamber coupled in flow communication with the air inlet, and a tubesheet dividing the filter chamber into a first dirty air compartment and a second clean air compartment, the tubesheet including a plurality of apertures therethrough. The gas turbine engine system also includes a plurality of filter elements, each of the plurality of filter elements positioned in the dirty air compartment and coupled to the tubesheet in flow communication with a respective one of the plurality of apertures such that air entering the clean air compartment from the dirty air compartment passes through at least some of the plurality of filter elements and respective apertures, and a shutter operatively positioned in the clean air compartment and configured to selectably cover at least one of the plurality of apertures, the shutter translatable from a first position covering a first set of the plurality of apertures to a second position covering a second set of the plurality of apertures.

### BRIEF DESCRIPTION OF THE DRAWINGS

FIGS. 1-6 show exemplary embodiments of the method and apparatus described herein.

FIG. 1 is a schematic cross-sectional view of a gas turbine intake filtration system in accordance with an example embodiment of the present disclosure.

FIG. 2 is a side elevation view of the air filter shown in FIG. 1 in accordance with an example embodiment of the present disclosure.

FIG. 3 is a front elevation view of a portion of a tubesheet and shutter assembly in accordance with an example embodiment of the present disclosure.

FIG. 4 is a perspective view of an embodiment of a tubesheet and shutter assembly in accordance with another example embodiment of the present disclosure.

FIG. 5A is a front elevation view of a shutter assembly in a first position.

FIG. 5B is a front elevation view of the shutter assembly shown in FIG. 5 in a second position.

FIG. 5C is a front elevation view of the shutter assembly shown in FIG. 5 in a third position 506.

FIG. 6 is a flow diagram of a method 600 of online filter element replacement in accordance with an example embodiment of the present disclosure.

Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION OF THE DISCLOSURE

The following detailed description illustrates embodiments of the disclosure by way of example and not by way of limitation. It is contemplated that the disclosure has general application to fluid flow control. It is further contemplated that the methods and systems described herein may be incorporated into existing air filtration systems, in addition to being maintained as a separate stand-alone flow control device.

An online filter element replacement system and method are described herein. The disclosure includes a filter screen or blank plate positioned at a downstream side of the air filter cartridges as an obstruction in the clean air path for the particular elements to be replaced, which will reduce or eliminate air bypass around the remaining filters during the replacement operation. The disclosure provides advantages that include avoiding a plant or gas turbine engine shutdown during the replacement operation, retrofit to existing systems capability, automatic or manual positioning of airflow blocking shutter, and permitting continued operations in cold climate, foggy as well as dusty environment, and coastal areas where frequent replacements of filters are necessary.

Embodiments of the disclosure describe that air bypass (unfiltered air entering into the gas turbine engine) during online filter elements replacement can be eliminated by using a filter screen in the clean air path, in the downstream side of particular segment of filters. The same filter screen can be used for different segments of filters replacement by moving it laterally, both in horizontal and vertical directions.

The following description refers to the accompanying drawings, in which, in the absence of a contrary representation, the same numbers in different drawings represent similar elements.

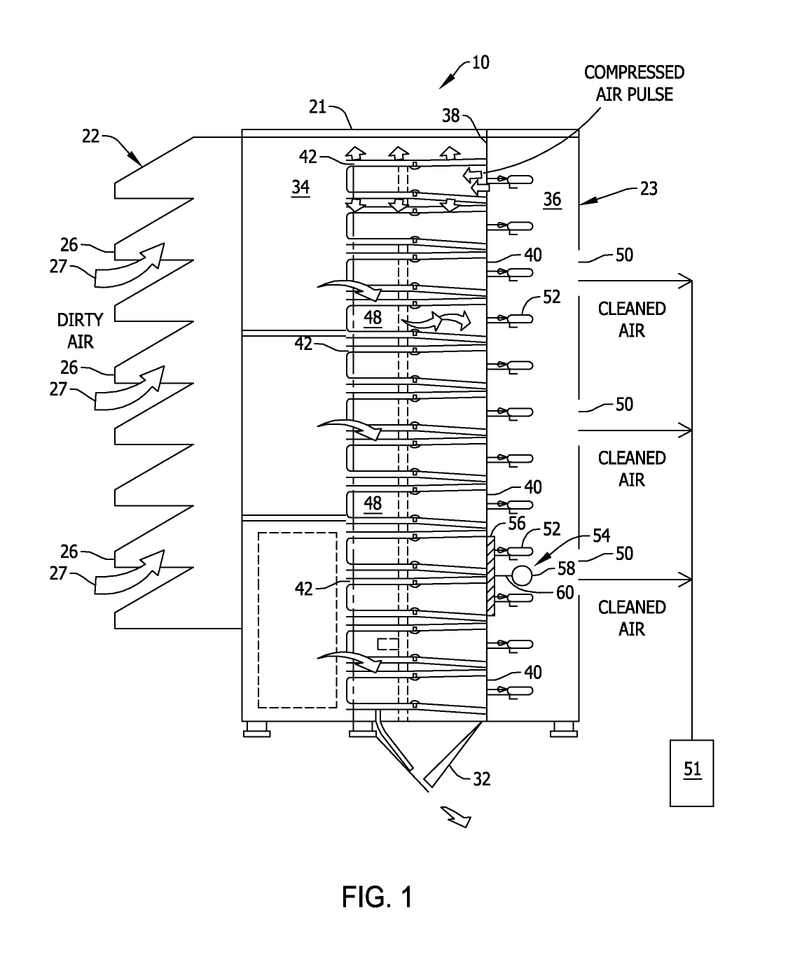

FIG. 1 is a schematic cross-sectional view of a gas turbine intake filtration system 10 in accordance with an example embodiment of the present disclosure. System 10 may be used, for example, for filtering intake air to a gas turbine engine system 51 having an air flow demand on the order of, for example, 8000 to 1.2 million cubic feet per minute (cfm). In the example embodiment, system 10 includes a chamber 21 having an air inlet side 22 and an air outlet side 23. A flow of air 27 enters chamber 21 through a plurality of vertically spaced inlet hoods 26 positioned along air inlet side 22. Inlet hoods 26 function to protect internal filters of system 10 from the effects of rain, snow and sun.

Chamber 21 of system 10 is divided into an upstream volume 34 and a downstream volume 36 by a tubesheet 38. Upstream volume 34 generally represents a dirty air section of intake filtration system 10, while the downstream volume generally represents a clean air section of intake filtration system 10. Tubesheet 38 defines a plurality of apertures 40 for allowing air to flow from upstream volume 34 to downstream volume 36. Each aperture 40 is covered by an air filter 42 or filter cartridge located in upstream volume 34 of chamber 21. Filters 42 are arranged and configured such that air flowing from upstream volume 34 to downstream volume 36 passes through filters 42 prior to passing through apertures 40. Each filter 42 is generally co-axially aligned with respect to its corresponding aperture 40 and has a longitudinal axis that is generally horizontal.

During filtering, air is directed from upstream volume 34 radially through air filters 42 into an interior volume 48 of filters 42. After being filtered, the air flows from interior volume 48 through tubesheet 38, via apertures 40, into downstream clean air volume 36. The clean air is then drawn out from downstream volume 36, through one or more apertures 50, into a gas turbine air intake, not shown. In various embodiments, air filters 42 may be round canisters, square static filters, or other configurations.

In various embodiments, each aperture 40 of tubesheet 38 includes a pulse jet air cleaner 52 mounted in downstream volume 36. Periodically, pulse jet air cleaner 52 is operated to direct a pulse jet of air backwardly through associated air filter 42, i.e. from interior volume 48 of air filter 42 outwardly to dislodge particulate material trapped in or on the filter media surface of air filter 42. Pulse jet air cleaners 52 can be sequentially operated across chamber 21 to eventually direct dust particulate material blown from air filters 42 into a dust collection hopper 32, for removal. In some embodiments, system 10 does not include a pulse jet air cleaner 52 at all.

In various embodiments, each air filter 42 may include cylindrical filters and/or frusto-conically shaped filters that are about four feet long and about one foot to about one and a half feet in diameter.

A shutter system 54 includes a shutter assembly 56, a shutter actuator 58, and a linkage 60. Shutter assembly 56 is configured to block or restrict flow air flow through one or more of air filters 42 while system 10 is operating online to permit removal of air filters 42 associated with shutter assembly 56. In one embodiment, shutter assembly 56 is positioned on a downstream side of air filter 42 and specifically, on a downstream side of tubesheet 38 such that apertures 40 associated with respective air filters 42 are covered to reduce or stop the flow of air through air filter 42. In various embodiments, shutter assembly 56 is formed of a solid material that does not permit air to pass through. In other embodiments, shutter assembly 56 is formed of a porous material that is capable of filtering the air passing through respective aperture 40. Actuator 58 is coupled to shutter assembly 56 through linkage 60 to permit shutter assembly 56 to be manipulated from a remote location either under automatic or manual control. Actuation of shutter assembly 56 permits moving shutter assembly 56 from a first location to a second location. At the first location, shutter assembly 56 may cover a first set of apertures 40 and at the second location, shutter assembly 56 may cover a second set of apertures 40. In a third location, shutter assembly 56 may be stored for normal operation of system 10 and would not be covering any of apertures 40. Cleaned air that has passed through air filters 42 enters downstream volume 36 and is directed through one or more apertures 50 to gas turbine engine 51.

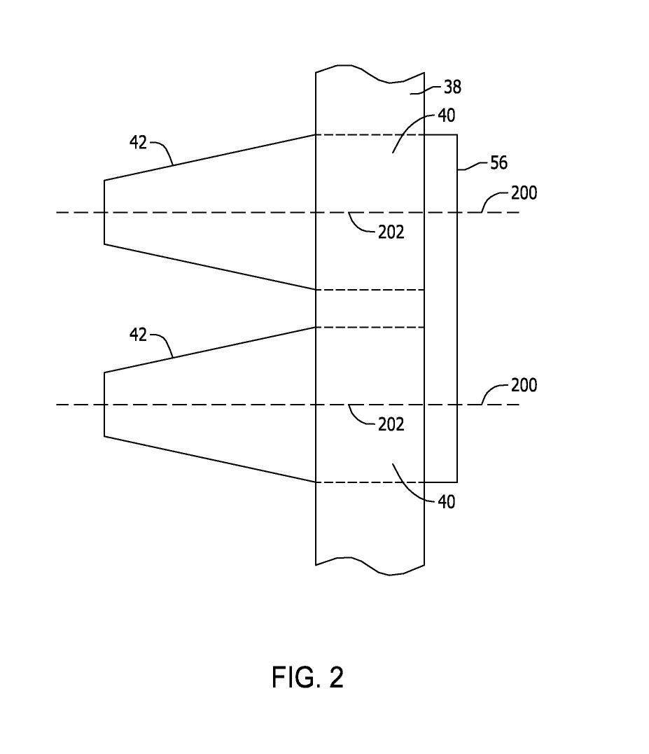

FIG. 2 is a side elevation view of air filter 42 in accordance with an example embodiment of the present disclosure. Each air filter 42 includes a longitudinal axis 200 that is coaligned with an approximate center 202 of a respective aperture 40. Shutter assembly 56 is shown in position to cover apertures 40 and to seal at least partially against tubesheet 38.

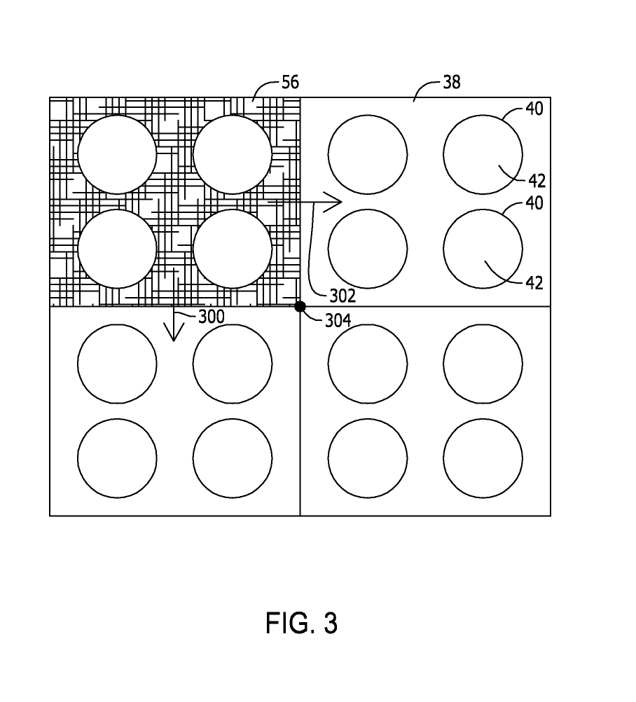

FIG. 3 is a front elevation view of a portion of tubesheet 38 and shutter assembly 56 in accordance with an example embodiment of the present disclosure. In the example embodiment, sixteen apertures 40 are shown in a four-by-four grid, however in other embodiments, apertures 40 may be spaced apart in other configurations. Shutter assembly 56 is configured to translate laterally in a vertical direction 300 or a horizontal direction 302. Accordingly shutter assembly 56 may be used to sequentially cover various sets of apertures 40 to affect a selectable filter replacement schedule. The replacement schedule may be a periodic or may be based on a degradation of performance of one or more air filters 42. In various embodiments, shutter assembly 56 is pivotally translatable about a pivot 304 extending orthogonally away from tubesheet 38 (out of the page in FIG. 3). In various embodiments, shutter assembly 56 is configured to be operated manually from the dirty air section, upstream volume 34, of intake filtration system 10.

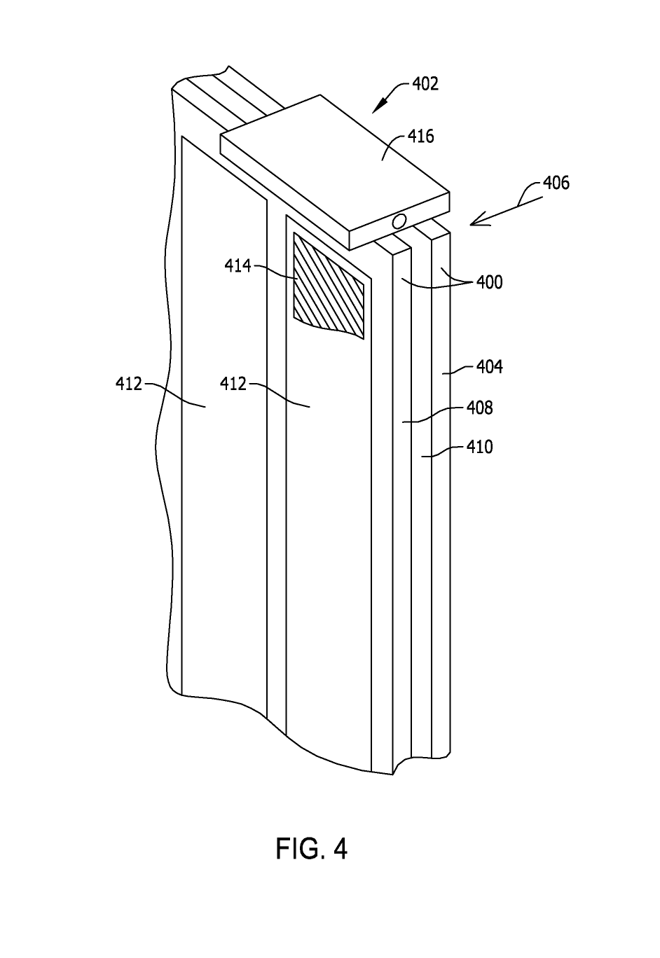

FIG. 4 is a perspective view of an embodiment of a tubesheet 400 and shutter assembly 402 in accordance with another example embodiment of the present disclosure. In the example embodiment, tubesheet 400 is of a double-wall construction having an upstream wall 404 in the direction of air flow 406 and a downstream wall 408. Walls 404 and 408 are spaced apart forming a gap 410 between them. Various apertures 412 are formed through walls 404 and 408 to permit passage of air through tubesheet 400. A shutter 414 is positioned within gap 410 and is translatable within gap 410 using an actuator 416. In one embodiment, shutter 414 comprises a fabric that is unrolled by action of actuator 416 to cover apertures 412 to block flow through one or more air filters 42 (shown in FIGS. 1 and 2). In various embodiments, shutter 414 comprises a solid non-porous material that is formed of interconnected slats that can be unrolled similar to a fabric shutter or roll-top desk. The roll of slats is unrolled to translate shutter 414 between walls 404 and 408 to cover one or more apertures 40 (shown in FIGS. 1 and 2). Shutter 414 may include gaps in coverage such that only one aperture 412 is covered at a time. Shutter 414 may also have different-sized and/or non-contiguous gaps such that several adjacent or several non-adjacent apertures 412 may be covered at one time. Also more than one shutter assembly 402 may be used in series according to airflow to permit cooperation between shutter assemblies 402 for more versatile control of removal of air filters 42. As described herein, shutter 414 and downstream wall 408 are positioned in the clean air section of system 10.

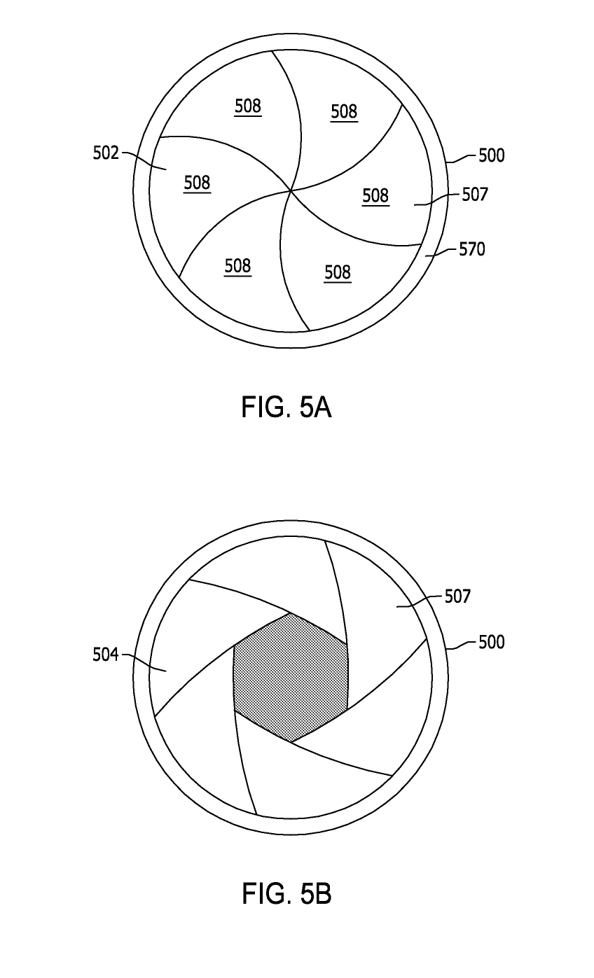

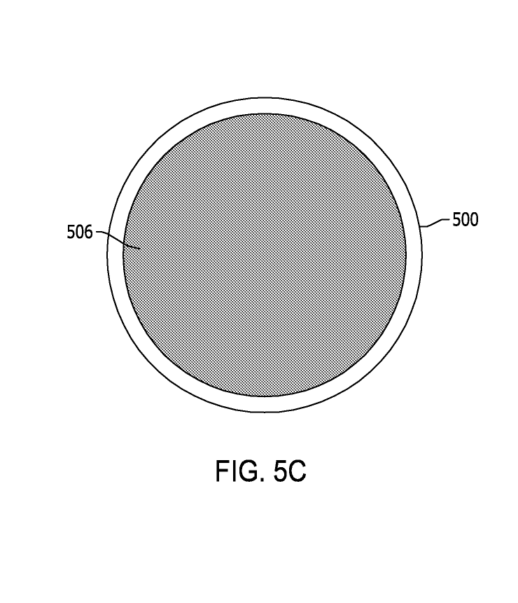

FIG. 5A is a front elevation view of a shutter assembly 500 in a first position 502. FIG. 5B is a front elevation view of shutter assembly 500 in a second position 504. FIG. 5C is a front elevation view of shutter assembly 500 in a third position 506. In the example embodiments, first position 502 is a substantially closed position, where most if not all airflow attempting to pass through shutter assembly 500 is blocked. Second position 504 is an intermediate position between first position 502 and third position 506. Third position 506 is a substantially open position, where a maximum amount of airflow is permitted through shutter assembly 500. In this embodiment shutter assembly 500 operates similarly to a camera diaphragm, however, as opposed to controlling an amount of light passing through shutter assembly 500, an amount of airflow is controlled. In the example embodiment, shutter assembly 500 comprises a diaphragm 507 comprising a plurality of leaves 508 selectably positionable about a circumference 510 of shutter assembly 500 between substantially closed position 502 and substantially open position 506.

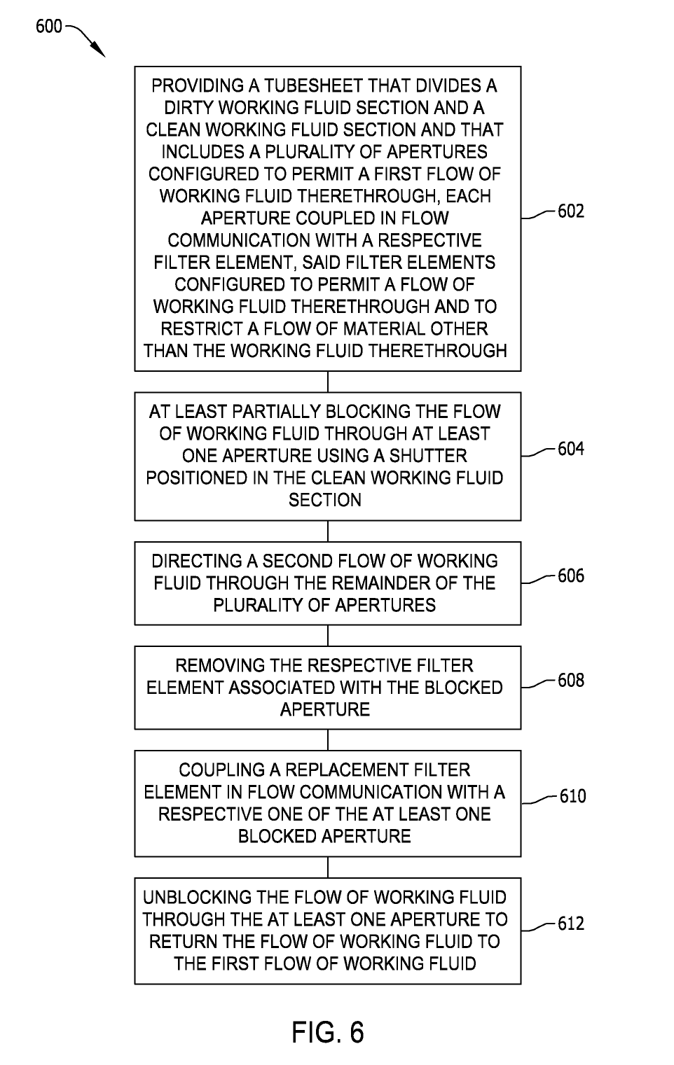

FIG. 6 is a flow diagram of a method 600 of online filter element replacement in accordance with an example embodiment of the present disclosure. In the example embodiment, method 600 includes providing 602 a tubesheet that divides a dirty working fluid section and a clean working fluid section and that includes a plurality of apertures configured to permit a first flow of working fluid therethrough, each aperture coupled in flow communication with a respective filter element, said filter elements configured to permit a flow of working fluid therethrough and to restrict a flow of material other than the working fluid therethrough. Method 600 also includes at least partially blocking 604 the flow of working fluid through at least one aperture using a shutter positioned in the clean working fluid section, directing 606 a second flow of working fluid through the remainder of the plurality of apertures, and removing 608 the respective filter element associated with the blocked aperture. Method 600 further includes coupling 610 a replacement filter element in flow communication with a respective one of the at least one blocked aperture and unblocking 612 the flow of working fluid through the at least one aperture to return the flow of working fluid to the first flow of working fluid.

In various embodiments, method 600 includes translating the shutter from a stored position to a first blocking position aligned with the at least one aperture. Method 600 may also include translating the shutter from the first blocking position aligned with the at least one aperture to a second blocking position aligned with the at least one other aperture and translating the shutter from a blocking position aligned with the at least one other aperture to the stored position. Additionally, method 600 may also include at least partially blocking the flow of working fluid through at least one aperture using a shutter controlled by an actuator coupled to the shutter.

It will be appreciated that the above embodiments that have been described in particular detail are merely example or possible embodiments, and that there are many other combinations, additions, or alternatives that may be included.

While the disclosure has been described in terms of various specific embodiments, it will be recognized that the disclosure can be practiced with modification within the spirit and scope of the claims.

The above-described embodiments of a method and system of managing flow through an air filtration system to permit online replacement and/or cleaning of air filter cartridges provides a cost-effective and reliable means for manually or automatically sealing portions of an air filter tubesheet to permit removal of the filter cartridges. More specifically, the methods and systems described herein facilitate controlling the placement of a blocking plate or shutter over apertures in the tubesheet through which the air flow passes as it leaves the filter media. As a result, the methods and systems described herein facilitate maintaining power generation equipment operable in a cost-effective and reliable manner.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An online air filter replacement system comprising:
a filter chamber;
a tubesheet dividing said filter chamber into a first dirty air compartment and a second clean air compartment, said tubesheet comprising a plurality of apertures therethrough;
a plurality of filter elements, each of the plurality of filter elements positioned in the dirty air compartment and coupled to said tubesheet in flow communication with a respective one of said plurality of apertures such that air entering the clean air compartment from the dirty air compartment passes through at least some of said plurality of filter elements and respective apertures; and
a shutter operatively positioned in the clean air compartment and configured to selectably cover at least one of said plurality of apertures.

2. The system of claim 1, wherein said shutter is translatable from a first position covering a first set of said plurality of apertures to a second position covering a second set of said plurality of apertures.

3. The system of claim 1, wherein said tubesheet comprises a first wall spaced-apart from a second wall to form a gap between said first and second walls.

4. The system of claim 3, wherein said shutter is positioned within the gap formed between the first wall and second wall.

5. The system of claim 3, wherein said shutter is translatable within the gap formed between the first wall and second wall.

6. The system of claim 1, wherein said shutter comprises a diaphragm selectably positionable between a substantially closed position and a substantially open position.

7. The system of claim 1, further comprising an actuator coupled to said shutter, said actuator configured to translate said shutter laterally with respect to said tubesheet.

8. The system of claim 1, wherein said shutter is configured to rotate about a pivot between the first position and the second position.

9. The system of claim 1, wherein said shutter is configured to translate in at least one of a vertical direction and a horizontal direction between the first position and the second position.

10. A method for using the online air filter replacement system of claim 1, said method comprising:
at least partially blocking a flow of working fluid through at least one aperture using the shutter positioned in a clean working fluid section;
directing a second flow of working fluid through the remainder of the plurality of apertures;
removing the respective filter element associated with the blocked aperture;
coupling a replacement filter element in flow communication with a respective one of the at least one blocked aperture; and
unblocking the flow of working fluid through the at least one aperture to return the flow of working fluid to the first flow of working fluid.

11. The method of claim 10, wherein at least partially blocking the flow of working fluid comprises translating the shutter from a stored position to a first blocking position aligned with the at least one aperture.

12. The method of claim 11, wherein at least partially blocking the flow of working fluid comprises translating the shutter from the first blocking position aligned with the at least one aperture to a second blocking position aligned with the at least one other aperture.

13. The method of claim 11, wherein at least partially blocking the flow of working fluid comprises translating the shutter from a blocking position aligned with the at least one other aperture to the stored position.

14. The method of claim 10, wherein at least partially blocking the flow of working fluid comprises at least partially blocking the flow of working fluid through at least one aperture using a shutter controlled by an actuator coupled to the shutter.

15. The system of claim 1 further comprising:
a gas turbine engine comprising an air inlet;
the filter chamber coupled in flow communication with the air inlet.

16. The system of claim 15, wherein said shutter is translatable from a first position covering a first set of said plurality of apertures to a second position covering a second set of said plurality of apertures.

17. The system of claim 15, wherein said tubesheet comprises a first wall spaced-apart from a second wall to form a gap between said first and second walls.

18. The system of claim 17, wherein said shutter is translatable within the gap formed between the first wall and second wall.

19. The system of claim 15, wherein said shutter comprises a diaphragm selectably positionable between a substantially closed position and a substantially open position.

20. The system of claim 15, further comprising an actuator coupled to said shutter, said actuator configured to translate said shutter laterally with respect to said tubesheet.

21. The system of claim 15, wherein said shutter is configured to rotate about a pivot between the first position and the second position.

22. The system of claim 15, wherein said shutter is configured to translate in at least one of a vertical direction and a horizontal direction between the first position and the second position.
